(19) United States
(12) Patent Application Publication
(10) Pub. No.: US 2003/0029193 A1
(43) Pub. Date: Feb. 13, 2003

(54) Method of forming metalloxane polymers

(76) Inventors: Xiangdong Feng, Broadview Heights, OH (US); Wei Zhang, Wickliffe, OH (US); Charles A. Baldwin, Parma, OH (US); William D. Faust, Aurora, OH (US); Graham B. Rose, Broadview Hts., OH (US)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(21) Appl. No.: 09/878,162

(22) Filed: Jun. 8, 2001

(51) Int. Cl. C03B 8/02

(52) U.S. Cl. 65/17.2

(57) ABSTRACT

The present invention provides a method of forming a coating including a metalloxane polymer on a substrate. The method according to the invention includes forming a non-aqueous mixture including an alkoxide, a siloxane, and an organo-metallic catalyst, applying the mixture to the substrate, and heating the substrate to cure the coating. The mixture can also comprise one or more fillers including ceramic powders, glass powders, metal powders, and pigments The method can be used to apply coatings to metal, glass, porcelain enamel, ceramic, and polymeric substrates.

### FIELD OF INVENTION

The present invention provides a method of forming a coating comprising a metalloxane polymer on a substrate, a method of forming a solid comprising a metalloxane polymer, and a method of forming a monolith glass.

### BACKGROUND OF THE INVENTION

One of the known processes for forming metalloxane polymers is the sol-gel process. The sol-gel process involves the gelation of a colloidal suspension (sol) to form a inorganic polymer network in a continuous phase (gel). Alkoxides, which are compounds having the formula M(OR)ₙ, where R is an organic ligand and n is an integer equal to or less than the valence of the element M, are used in the conventional sol-gel process because they react readily with water. The most widely used alkoxides are alkoxysilanes, but other alkoxides such as aluminates, titanates, zirconates, and borates are also frequently used.

The first reaction in the conventional sol-gel process is a hydrolysis reaction. Water replaces one or more alkoxide groups (OR) with hydroxyl groups (OH) to form silanol groups (Si—OH). A subsequent condensation reaction between silanol groups produces siloxane bonds (Si—O—Si) plus by-products. Under most conditions, condensation commences before hydrolysis is complete. However, by carefully controlling pH, temperature, H₂O/Si molar ratio, reaction time, reagent concentrations, catalysts, and other process parameters, the reaction can be controlled to some degree.

Generally speaking, the conventional sol-gel process requires the presence of an acid or a base and water in order to promote the hydrolysis and condensation of alkoxides. Hydrolysis rates vary widely among alkoxides, which makes it very difficult to prepare sol-gel coating systems containing mixtures of two or more different alkoxides. Furthermore, because of the reactive nature of alkoxides and the presence of water, conventional sol-gel coating systems are known to have a relatively short shelf-life.

### SUMMARY OF INVENTION

The present invention provides a method of forming a coating including a metalloxane polymer on a substrate. The method according to the invention includes forming a non-aqueous mixture including an alkoxide, a siloxane, and an organo-metallic catalyst, applying the mixture to the substrate, and heating the substrate to cure the coating. The mixture can also comprise one or more fillers including ceramic powders, glass powders, metal powders, and pigments. The method can be used to apply coatings to metals, glasses, vitreous surfaces such as porcelain enamels and glazes, ceramics, and polymeric substrates. Coatings formed according to the method of the invention are hydrophobic, acid resistant, and scratch resistant.

The method according to the present invention does not require the use of acids or bases and water to promote the hydrolysis and condensation of alkoxides. Thus, the method can be used to form metalloxane polymers using a variety of alkoxides having different hydrolysis rates. The avoidance of water has the added advantage of improving the shelf-life of the coating mixture. Furthermore, protective complexing agents such as, for example, acetyl acetone, polyethylene glycol, and diethylene glycol, can be used to stabilize the coating mixture and further extend the shelf-life.

The present invention also provides a method of forming a solid comprising a metalloxane polymer. The method comprises heating a non-aqueous mixture comprising an alkoxide, a siloxane, and an organo-metallic catalyst to form said solid comprising a metalloxane polymer. Solids thus formed can be sintering to form monolith glasses. o The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### DETAILED DESCRIPTION OF THE PREFERRED EMBODIMENT

As noted above, the present invention provides a method of forming a coating comprising a metalloxane polymer on a substrate. The method according to the invention comprises forming a non-aqueous mixture including an alkoxide, a siloxane, and an organo-metallic catalyst, applying the mixture to the substrate, and heating the substrate to cure the coating.

Throughout the instant specification and in the appended claims, the term “non-aqueous” means that no water is intentionally added to or caused to be present in the mixture. It will be appreciated that the term “non-aqueous” is not intended to be absolute. Trace amounts of water, such as may be inherent in the air, in or on the substrates, or in the components comprising the mixture, may nonetheless be present. However, in general, the presence of water is to be avoided, and most of the components of the mixture will contain relatively little, if any, water.

The alkoxides used in the method according to the invention are compounds that can be represented by the formula M(OR)ₙ, where M is an element, OR is an alkoxy group, and n is an integer less than or equal to the valence of the element M. It will be appreciated that the foregoing formula does not exclude alkoxides represented by the formula (R′)ₙM(OR)ᵥ₋ₙ, where M is an element, OR is an alkoxy group, n is an integer less than or equal to the valence of the element M, and organic ligand R′ is the same or different than R. In the preferred embodiment of the invention, the element M is selected from the group consisting of silicon, titanium, zirconium, aluminum, cerium, boron, zinc, copper, nickel, cobalt, germanium, manganese, molybdenum, chromium, iron, vanadium, magnesium, calcium, strontium, and barium, with silicon, titanium, germanium, zirconium, and aluminum being presently most preferred.

Any of the known siloxanes can be used in the method according to the invention. The siloxanes can be alkoxy terminated, hydroxy terminated, and hydrogen terminated. The presently most preferred siloxane for use in the invention is a methoxy-terminated dimethyl phenyl siloxane available commercially from Dow Corning under the trade designation Dow Corning 3074.

The mixture can optionally further comprise one or more fillers to increase the final hardness of the coating and/or to impart other desired physical and/or chemical properties to the coating. Suitable fillers for use in the invention include ceramic powders, glass powders, metal powders, and pigments. Generally speaking, fillers will have a particle size less than about 50 microns, and more preferably less than about 10 microns. Preferred fillers include powders of Al₂O₃, SiO₂, TiO₂, ZnO, Zn powder, ZrO₂, and ZrSiO₄.

In one embodiment of the invention, the mixture is applied to the surface of a substrate and then cured to form a coating. Suitable substrates include metals, such as steel, stainless steel, aluminum, copper, brass, and iron, glasses, vitreous surfaces such as porcelain enamels and glazes, ceramics, and various polymers, such as acrylics, polycarbonates, acrylonitrile-butadiene-styrene polymers, polyesters, and polyolefins. The substrate preferably has surface hydroxyl groups, which can be inherent in the material of the substrate or can be, in some cases, created by other processes or surface treatments.

The present method utilizes organo-metallic catalysts and heat to promote condensation reactions between alkoxides, siloxanes, and substrates and fillers having hydroxyl functional groups. The preferred organo-metallic catalysts for use in the method according to the present invention are organo-tin catalysts. Dibutyltin dilaurate is presently most preferred organo-tin catalyst for use in the invention, but other organo-tin catalysts can also be used. Additional examples include dibutyltin diacetate, dibutyltin didodecanoate, bis(acetoxydibutyltin) oxide, tetrakis(acetoxydibutyltin)silane, and dibutyidimethoxystannane.

Upon heating, the organo-metallic catalysts catalyze a variety of condensation reactions between alkoxides and: (a) alkoxy terminated siloxanes; (b) hydroxy terminated siloxanes; (c) hydrogen terminated siloxanes; (d) alkoxides; and (e) hydroxyl groups on the surface of fillers or substrates. For example, the organo-metallic catalysts can catalyze a reaction between an alkoxide (e.g., methyltriethoxysilane) and an alkoxy terminated siloxane (e.g., tetraethoxysilane) to form a metalloxane polymer as follows:

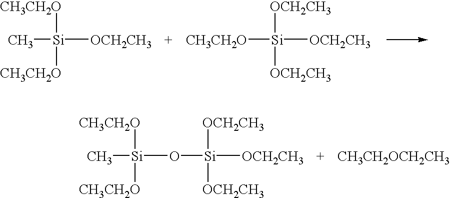

It will be appreciated that other organic groups (e.g., phenol “Ph”) can be present on the alkoxide and/or the siloxane, as illustrated below:

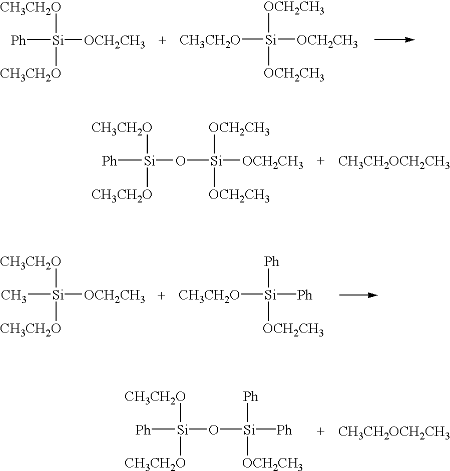

As additional reactions occur, long metalloxane polymer chains and networks form, such as generally illustrated below:

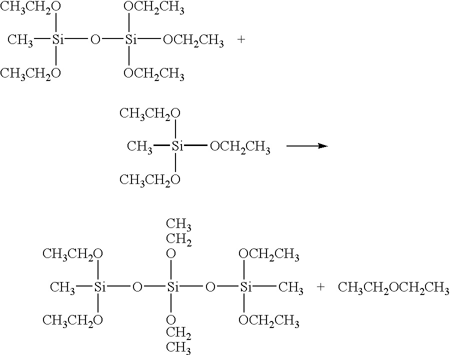

The organo-metallic catalysts are also capable of catalyzing reactions between alkoxides and hydroxyl groups present on the surface of substrates and fillers (“X”), as illustrated in the reactions below:

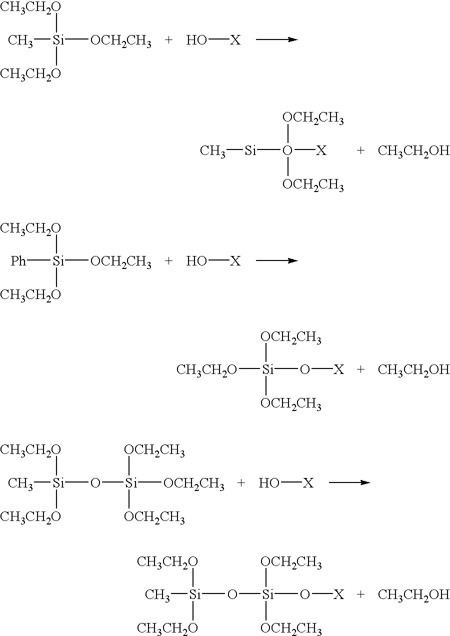

The organo-metallic catalysts also catalyze reactions among alkoxides, hydroxyl terminated siloxanes, and the hydroxyl groups on the surface of fillers and substrates, as generally illustrated below:

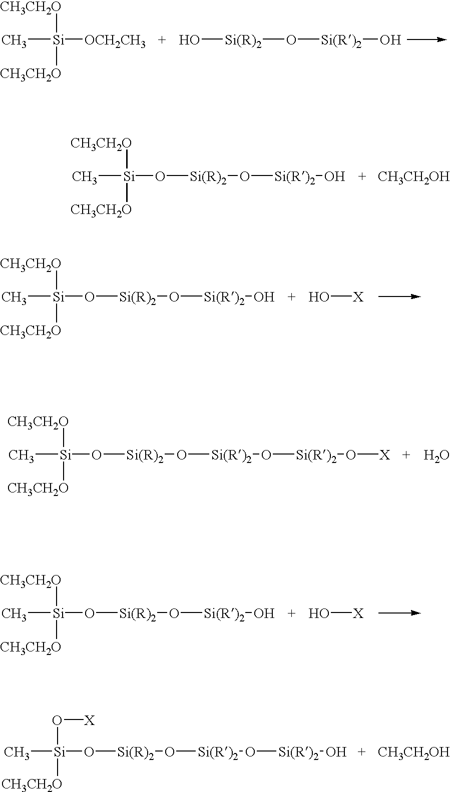

And, the organo-metallic catalysts catalyze reactions among alkoxides, hydrogen terminated siloxanes, and hydroxyl groups on the surface of fillers and substrates, as generally illustrated in the equations below:

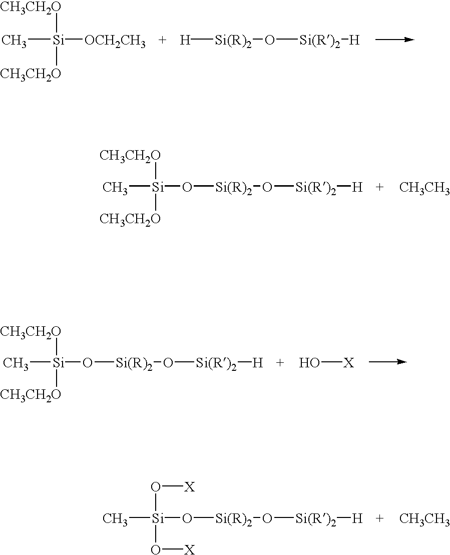

Because the method of the present invention does not involve water hydrolysis, it is possible to use alkoxides with different hydrolysis rates in the same coating composition. Thus, virtually any element that can be made into an alkoxide (including Alkaline Earth metals) can be incorporated into coatings. Thus, it is possible to make multiple component metalloxane polymer coating systems.

When highly reactive alkoxides are used, or when the coating is being applied to a substrate in an environment where there is high humidity, it is sometimes advantageous for the mixture to further comprise one or more complexing agents to stabilize the composition. Suitable complexing agents are those which form complexes with the element “M” that is more stable in the presence of water than an alkoxide. Particularly preferred complexing agents for use in the method of the present invention include acetyl acetone, polyethylene glycol, and diethylene glycol.

The avoidance of water in the composition has the added benefit of increasing the shelf-life of the mixture. Furthermore, non-aqueous solutions are easier to prepare because the alkoxides are not prone to prematurely hydrolyze.

A variety of application methods can be used to apply the mixture to substrates. Suitable application methods include dip coating, spraying, flow coating, brushing, roller application, vapor deposition, and electrophoresis. Spraying, dip coating, and flow coating are preferred because of ease and speed.

Several coats of the mixture can be applied and cured to form desired coatings. For example, a first layer of a mixture containing a ceramic powder and a pigment may be applied to form an adherent, hard, scratch resistant, matte finish. Then a second coat of a mixture containing no ceramic filler can be applied to provide a somewhat flexible, transparent, glossy finish.

The mixture is preferably prepared in a dry mixing vessel. The order of addition is not per se critical, but it is generally preferred that the alkoxide(s) and siloxane(s) be intimately mixed together before the addition of the organo-metallic catalyst. Any fillers should be added to the mixture next, and then the entire mixture should be mixed until homogeneous. Complexing agents can be added at any point during preparation, but are generally mixed with the alkoxides that are easily hydrolyzed before they are mixed with other alkoxides, siloxanes, and catalysts.

When the mixture is applied to a substrate to form a coating, it is first permitted to air-dry. The mixture will have a liquid sheen, and can be substantially removed simply by wiping. In most instances, the mixture will not completely air dry. It must then be heated to cause the desired reactions to occur. Heating is usually accomplished in an oven. There is no critical heating or firing schedule, but it has been found that best results are obtained when heating is done in stages. For example, the coated substrate can be heated from room temperature (˜25° C.) to about 130° C. over the course of 5 to 60 minutes. Then, the temperature should be maintained for about 5 to about 60 minutes to allow the initial reactions to be completed. Next, the coated substrate should be heated to about 250° C. over the course of about 5 to about 15 minutes, and the temperature then maintained for about 5 to about 60 minutes to fully cure the coating. After heating, the coated substrate should be allowed to cool to room temperature. Heating should be sufficient to fully cure the coating composition. Curing at higher temperatures, such as at 400° C., usually provides a harder coating than a coating cured at a lower temperature such as 250° C.

Coatings formed according to the method of the invention are hydrophobic, and depending upon filler content, can be glossy to matte in appearance. Such coatings generally exhibit excellent spot acid resistance, and are scratch resistant.

Because the composition is essentially free of water, it is possible to form mixtures of several different alkoxides to form solids comprising multi-component metalloxane polymers. These solids do not necessarily have to be formed into coatings on substrates. On the contrary, it is possible to form solids comprising metalloxane polymers by pouring the mixture into containers or molds, and then heating the mixture to obtain a cured solid comprising a metalloxane polymer. Monolith glasses can be obtained by sintering the solid metalloxane polymer products.

The following examples are intended only to illustrate the invention and should not be construed as imposing limitations upon the claims.

### Testing Procedures

The following testing procedures were used to obtain the results reported in Example 1-12 below:

### Spot Acid Resitance

Spot acid resistance testing was derived from ISO 2722:1997, Vitreous and Porcelain Enamels—Determination of Resistance to Citric Acid at Room Temperature. In accordance with the procedures specified in that standard, a few drops of a 10% aqueous solution of citric acid are placed on a coated panel and covered with a watch glass. After 15 minutes, the watch glass was removed and parallel pencil marks were made on the affected area. The amount of etching was graded according to the scale shown below:

| | |
|---|---|
| AA | Pencil marks removed by rubbing with a dry paper towel |
| A | Pencil marks removed by rubbing with a wet paper towel |
| B | Pencil marks not removed by rubbing with a wet paper towel |
| C | The etched area still reflects an incident light source |
| D | The etched area does not reflect an incident light source |
| F | The citric acid removes a portion of the coating |

### Thickness of Applied Coatings

Coating thickness measurements were made using a PosiTector 6000 thickness gauge available from DeFelsko Corporation.

### Cross-Hatch Adhesion Test

The cross-hatch adhesion test was derived from ASTM D-3359-97, Standard Test Methods for Measuring Adhesion by Tape Test, and ISO-2409-1992, Paints and Varnishes—Cross-Cut Test. The required equipment for conducting the test includes a cutting tool (e.g., razor blade, scalpel, or knife), a cutting guide (e.g., steel straight-edge), 1-inch wide semitransparent pressure-sensitive adhesive tape, and a pencil having an eraser. The test is conducted under normal ambient temperatures and humidity.

To conduct the test, a coated area free from surface defects is selected. For coatings having a thickness of up to 2.0 mils, a series of 11 vertical and 11 horizontal intersecting cuts spaced 1 mm apart are made to the substrate using the cutting tool and cutting guide to form a cross-hatch pattern. For coatings greater than 2.0 mils in thickness, the cuts are spaced 2 mm apart and only 6 vertical and 6 horizontal intersecting cuts are made to form a cross-hatch pattern. Any loose debris is carefully removed after making the cuts. Then, the adhesive tape is placed over the cross-hatched area. A pencil eraser is used to rub and press the tape against the cross-hatched area for 5 seconds. After about 90 seconds, the tape is rapidly removed (e.g., using a stripping motion). The cross-hatched area is inspected and graded as shown below. After the initial inspection and grading is completed, the panel is boiled in water for 15 minutes. Once the panel cools to ambient temperature, tape is reapplied to the cross-hatched area as described. Upon removal of the tape, the cross-hatched area is inspected and graded as shown below:

| | |
|---|---|
| 5B | 0% of the cross-hatched area removed |
| 4B | Less than 5% of the cross-hatched area removed |
| 3B | Between 5% and 15% of the cross-hatched area removed |
| 2B | Between 15% and 35% of the cross-hatched area removed |
| 1B | Between 35% and 65% of the cross-hatched area removed |
| 0B | Greater than 65% of the cross-hatched area removed |

### Scratch Hardness Test

An aluminum screwdriver head was used for the scratch hardness test. If the aluminum scratched the coating, the coating failed the test. If, however, the aluminum was scratched or otherwise degraded by the coating, the coating passed the test.

24 ft-lb Impact Test

The 24 ft-lb impact test was derived from Standard EN 10209, which defines a scale of five ratings, from a value of excellent adhesion to a value of poor adhesion. According to the testing procedure, a weight is dropped onto the panel from a height that causes it to hit the panel with 24 ft-lbs (32.5 J) of kinetic energy. The damage to the panel is then assessed. A rating of excellent is reported for a coating that continues to be fully adhered to the panel at the impact area after the test. Lesser ratings are very good, good, fair, poor, and none, which is analogous to Standard EN 10209.

### EXAMPLE 1

Base Solution 1 (BS-1) was formed by thoroughly mixing 150 g phenyltriethoxysilane (Gelest #SIP 6821), 150 g methyltriethoxysilane (Gelest #SIM 6555), and 150 g methoxy-terminated dimethyl-phenyl siloxane (Dow Corning 3074) in a 500 ml plastic bottle. Then 24 g dibutyltin dilaurate (Aldrich #29123-4) was added and the solution was shaken for an additional 30 minutes.

### EXAMPLE 2

12 g colloidal silica dispersed in isopropanol (Nissan Chemical IPA-ST-S) and 3 g zinc oxide powder (Fischer Z52-500g) were added to 45 g of Base Solution 1 (BS-1) from Example 1 and speed mixed with 6 beads for 3 minutes. The solution was then sprayed onto a steel plate that had previously been cleaned using a detergent and air dried. The thickness of the applied coating was about 25 microns. The coating was permitted to air dry for about 3 minutes, and then the coated steel plate was placed into an oven and heated according to the following schedule: from room temperature (25° C.) to about 130° C. in about 30 minutes; held at 130° C. for about 30 minutes; heated from 130° C. to 250° C. in about 10 minutes; and held at 250° C. for about 30 minutes. The coated steel plate was then permitted to cool to room temperature (25° C.).

The coating was grey in color and had a matte appearance. The coating was hydrophobic and had a spot acid resistance to citric acid of AA. The cross-hatch tape adhesion was 100% both before and after the coated steel plate was boiled in water for 15 minutes. There was no detachment of the coating from the steel plate after a 24 ft-lb impact test.

### EXAMPLE 3

Coating Solutions 3-A through 3-P were formed by speed mixing the amounts of Base Solution 1 (BS-1) from Example 1, colloidal silica dispersed in isopropanol (Nissan Chemical IPA-ST-S), and inorganic powders as shown in Table 1 below with 6 beads for 3 minutes.

TABLE 1

| Solution | BS-1 | IPA-ST-S | Powder Type | Powder Amount | Coating Thickness |
|---|---|---|---|---|---|
| 3-A | 15.26 g | 4.35 g | Zircon | 4.08 g | 0.75 mils |
| 3-B | 15.19 g | 4.44 g | ZnO | 1.07 g | 0.70 mils |
| 3-C | 15.16 g | 4.05 g | ZnO | 1.13 g | 1.20 mils |
| 3-D | 15.05 g | 7.67 g | ZnO | 1.09 g | 0.80 mils |
| 3-E | 15.12 g | 4.05 g | Glass | 4.06 g | 0.75 mils |
| 3-F | 15.11 g | 4.05 g | Al₂O₃ | 4.03 g | 0.60 mils |
| 3-G | 15.02 g | 4.02 g | ZnO | 1.01 g | 0.55 mils |
| 3-H | 15.07 g | 10.22 g | ZnO | 1.09 g | 0.90 mils |
| | | | Al₂O₃ | 3.05 g | |
| 3-I | 15.13 g | 4.14 g | Zircon | 2.03 g | 0.60 mils |
| | | | Al₂O₃ | 2.06 g | |
| 3-J | 15.19 g | 4.01 g | Zircon | 2.03 g | 0.65 mils |
| | | | Glass | 2.07 g | |
| 3-K | 15.08 g | 4.04 g | Glass | 2.01 g | 0.70 mils |
| | | | Al₂O₃ | 2.04 g | |
| 3-L | 15.09 g | 9.77 g | Zircon | 4.11 g | 0.60 mils |
| 3-M | 15.01 g | 7.54 g | Zircon | 2.03 g | 0.30 mils |
| | | | Al₂O₃ | 2.06 g | |
| 3-N | 15.18 g | 7.60 g | Glass | 3.03 g | 1.05 mils |
| | | | ZnO | 1.06 g | |
| 3-O | 15.05 g | 7.56 g | Glass | 4.01 g | 0.85 mils |
| | | | Al₂O₃ | 4.02 g | |
| 3-P | 15.26 g | 7.57 g | Zircon | 4.07 g | 1.15 mils |
| | | | Glass | 4.02 g | |

Coating Solutions 3-A through 3-P were each separately sprayed onto steel plates that had previously been cleaned using a detergent and air dried. The coated steel plates were permitted to air dry for about 3 minutes, and then subjected to the same heating schedule as described in Example 2 above.

The color of the resultant coatings varied according to the color of the inorganic powder used. Each of the resultant coatings was hydrophobic and each exhibited a spot acid resistance to citric acid of AA. The cross-hatch tape adhesion was 100% both before and after the coated steel plates were boiled in water for 15 minutes. There was no detachment of the coatings from the steel plates after 24 ft-lb impact tests.

### EXAMPLE 4

15.11 parts by weight of Base Solution 1 (BS-1) from Example I was speed mixed with 4.08 parts by weight of colloidal silica dispersed in isopropanol (Nissan Chemical IPA-ST-S) and 6 beads for 3 minutes. The solution was then applied to cleaned-only steel, aluminum, glass, and porcelain enamel surfaces by dip coating. In each case, the coating solution was air dried on the substrate and then heated according to the schedule set forth in Example 2. The resultant coating obtained in each case was adherent and transparent.

### EXAMPLE 5

35.5 g methyltriethoxysilane (Gelest #SIM6555), 35.5 g methoxy-terminated dimethyl-phenyl siloxane (Dow Corning 3074), 20.8 g tetraethoxysilane (TEOS), and 6.5 g dibutyltin dilaurate were mixed well in a 100 ml plastic bottle and then aged at 70° C. for 3 hours. The solution was applied to steel, glass, aluminum, and porcelain enamel surfaces by dip coating. The applied coatings were then cured in an oven according to the heating schedule set forth in Example 2. The resulting coatings were transparent, glossy, and hydrophobic. Each coated article had a spot acid resistance to citric acid of AA. The cross-hatch tape adhesion was 100% both before and after the coated articles were boiled in water 15 minutes. There was no detachment of the coatings from the substrates after a 24 ft-lb impact test.

### EXAMPLE 6

35.5 g methyltriethoxysilane (Gelest #SIM6555), 35.5 g methoxy-terminated dimethyl-phenyl siloxane (Dow Corning 3074), 28.5 g titanium isoproxide, and 6.5 g dibutyltin dilaurate were mixed well in a 100 ml plastic bottle. 20 g acetyl acetone was then added and mixed well. The resulting coating solution was then applied to steel, glass, aluminum, and porcelain enamel parts by dip coating. The coated parts were then placed in a oven and heated from room temperature (25° C.) to 130° C. in about 30 minutes, and then held at 130° C. for about 30 minutes. The resultant coatings were transparent, glossy, hydrophobic, and acid resistant.

### EXAMPLE 7

36.5 g methyltriethoxysilane (Gelest #SIM6555), 35.5 g methoxy-terminated dimethyl-phenyl siloxane (Dow Corning 3074), 38.4 g zirconium butoxide, and 6.5 g dibutyltin dilaurate were mixed well in a 100 ml plastic bottle. 5.5 g acetyl acetone was then added and mixed well. The resulting coating solution was applied to steel, glass, aluminum, and porcelain enamel parts by dip coating. The coated parts were then placed in a oven and heated from room temperature (25° C.) to 130° C. in about 30 minutes, and then held at 130° C. for about 30 minutes. The resultant coatings were transparent, glossy, hydrophobic, and acid resistant.

### EXAMPLE 8

20.5 g methyltriethoxysilane (Gelest #SIM6555), 35.5 g methoxy-terminated dimethyl-phenyl siloxane (Dow Corning 3074), and 20.8 g TEOS were combined in a 100 ml plastic bottle and mixed well. 6.5 g dibutyltin dilaurate and 2.0 g of hydroxyl terminated dimethyl siloxane (Gelest DMS-S12-100GM) were then added to the solution and well mixed. The resulting coating solution was applied to steel, glass, aluminum, and porcelain enamel parts by dip coating. The coated parts were then placed in a oven and heated from room temperature (25° C.) to 130° C. in about 30 minutes, and then held at 130° C. for about 30 minutes. The resultant coatings were transparent, glossy, hydrophobic, and acid resistant.

### EXAMPLE 9

20.5 g methyltriethoxysilane (Gelest #SIM6555), methoxy-terminated dimethyl-phenyl siloxane (Dow Corning 3074), and 20.8 g TEOS were combined in a 100 ml plastic bottle and mixed well. 2.5 g hydrogen terminated dimethyl siloxane was added to the solution and mixed well. The resulting coating solution was applied to steel, glass, aluminum, and porcelain enamel parts by dip coating. The coated parts were then placed in a oven and heated from room temperature (25° C.) to 130° C. in about 30 minutes, and then held at 130° C. for about 30 minutes. The resultant coatings were transparent, glossy, hydrophobic, and acid resistant.

### EXAMPLE 10

A steel plate was coated with Coating Solution 3-G described in Example 3 by spraying and then subjected to heating according to the schedule described in Example 2. The coating was grey, matte, and hydrophobic. Next, the coating solution described in Example 4 was applied to the coated surface of the steel plate by dip coating. The twice-coated steel plate was again subjected to the same heating schedule as described in Example 2. The resulting coating was shiny, rather than matte, and hydrophobic.

### EXAMPLE 11

20.5 g methyltriethoxysilane (Gelest #SIM6555), 35.5 g methoxy-terminated dimethyl-phenyl siloxane (Dow Corning 3074), and 20.8 g TEOS were mixed well in a 100 ml plastic bottle. 6.5 g dibutyltin dilaurate and 10.0 g of hydroxyl terminated dimethyl siloxane (Gelest DMS-S12-100 GM) were added to the solution and mixed well. The solution was poured into a mold and become a monolith gel after heating at 70° C. for about 10 minutes. The gel was removed from the mold, air dried, and then sintered to form a monolith glass.

### EXAMPLE 12

20.5 g methyltriethoxysilane (Gelest #SIM6555), 35.5 g methoxy-terminated dimethyl-phenyl siloxane (Dow Corning 3074), 19.2 g zirconium butoxide, and 14.3 g titanium isoproxide were combined in a 100 ml plastic bottle and mixed well. 6.5 g dibutyltin dilaurate and 5.0 g hydroxyl terminated dimethyl siloxane (Gelest DMS-S12-100GM) were added to the solution and mixed well. The solution was poured into a mold and become a monolith gel after heating at 70° C. for about 10 minutes. The gel was removed from the mold, air dried, and then sintered to form a monolith glass.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed:

1. A method of forming a solid comprising a metalloxane polymer, said method comprising heating a non-aqueous mixture comprising an alkoxide, a siloxane, and an organo-metallic catalyst to form said solid.

2. The method according to claim 1 wherein said organo-metallic catalyst comprises an organo-tin catalyst.

3. The method according to claim 2 wherein said organo-tin catalyst comprises one or more selected from the group consisting of dibutyltin dilaurate, dibutyltin diacetate, dibutyltin didodecanoate, bis(acetoxydibutyltin) oxide, tetrakis(acetoxydibutyltin) silane, and dibutyidimethoxystannane.

4. The method according to claim 1 wherein said siloxane comprises an alkoxy terminated siloxane.

5. The method according to claim 1 wherein said siloxane comprises a hydroxyl terminated siloxane.

6. The method according to claim 1 wherein said siloxane comprises a hydrogen terminated siloxane.

7. The method according to claim 1 wherein said alkoxide comprises a compound represented by the formula M(OR)ₙ, where OR is an alkoxy group, n is an integer, and M is an element selected from the group consisting of silicon, titanium, zirconium, aluminum, cerium, boron, zinc, copper, nickel, cobalt, germanium, manganese, molybdenum, chromium, iron, vanadium, magnesium, calcium, strontium, and barium.

8. The method according to claim 1 wherein said mixture further comprises a filler.

9. The method according to claim 8 wherein said filler comprises one or more selected from the group consisting of ceramic powders, glass powders, metal powders, and pigments.

10. The method according to claim 9 wherein said filler comprises one or more selected from the group consisting of Al₂O₃, SiO₂, TiO₂, ZnO, Zn powder, ZrO₂, and ZrSiO₄.

11. The method according to claim 1 wherein said solid comprises a coating applied to a substrate.

12. The method according to claim 10 wherein said coating is applied to a metal, glass, porcelain enamel, ceramic, or polymeric substrate.

13. A method of forming a coating comprising a metalloxane polymer on a substrate, said method comprising forming a non-aqueous mixture comprising an alkoxide, a siloxane, and an organo-metallic catalyst, applying said mixture to said substrate, and heating said substrate to cure said coating.

14. The method according to claim 13 wherein said organo-metallic catalyst comprises an organo-tin catalyst.

15. The method according to claim 14 wherein said organo-tin catalyst comprises one or more selected from the group consisting of dibutyltin dilaurate, dibutyltin diacetate, dibtutyltin didodecanoate, bis(acetoxydibutyltin) oxide, tetrakis(acetoxydibutyltin) silane, and dibutyldimethoxystannane.

16. The method according to claim 13 wherein said siloxane comprises an alkoxy terminated siloxane.

17. The method according to claim 13 wherein said siloxane comprises a hydroxyl terminated siloxane.

18. The method according to claim 13 wherein said siloxane comprises a hydrogen terminated siloxane.

19. The method according to claim 13 wherein said alkoxide comprises a compound represented by the formula M(OR)ₙ, where OR is an alkoxy group, n is an integer, and M is an element selected from the group consisting of silicon, titanium, zirconium, aluminum, cerium, boron, zinc, copper, nickel, cobalt, germanium, manganese, molybdenum, chromium, iron, vanadium, magnesium, calcium, strontium, and barium.

20. The method according to claim 13 wherein said mixture further comprises filler.

21. The method according to claim 20 wherein said filler comprises one or more selected from the group consisting of ceramic powders, glass powders, metal powders, and pigments.

22. The method according to claim 21 wherein said filler comprises one or more selected from the group consisting of Al₂O₃, SiO₂, TiO₂, ZnO, Zn powder, ZrO₂, and ZrSiO₄.

23. The method according to claim 13 wherein said coating is applied to a metal, glass, porcelain enamel, ceramic, or polymeric substrate.

24. A method of forming a coating comprising a metalloxane polymer on a substrate, said method comprising forming a non-aqueous mixture comprising an alkoxide, methyltriethoxysilane, methoxy-terminated dimethyl, phenyl siloxane, and an organo-tin catalyst, applying said mixture to said substrate, and heating said substrate to cure said coating.

25. The method according to claim 24 wherein said alkoxide comprises one or more selected from the group consisting of phenyltriethoxy silane, tetraethoxy silane, titanium isoproxide, zirconium butoxide, hydroxyl terminated dimethyl siloxane, and hydrogen terminated dimethyl siloxane.

26. The method according to claim 24 wherein said mixture further comprises a filler selected from the group consisting of colloidal silica, ZnO powder, Zn powder, ZrSiO₄ powder, glass powder, and Al₂O₃ powder.

27. The method according to claim 24 wherein said organo-tin catalyst comprises dibutyltin dilaurate.

28. The method according to claim 24 further comprising a complexing agent.

29. The method according to claim 28 wherein said complexing agent comprises acetyl acetone, polyethylene glycol, and diethylene glycol.

30. A method of forming a monolith glass, said method comprising forming a non-aqueous mixture comprising an alkoxide, a siloxane, and an organo-metallic catalyst, heating said mixture to form a solid comprising a metalloxane polymer, and sintering said solid to form said monolith glass.
